(19) United States
(12) Patent Application Publication
(10) Pub. No.: US 2005/0228508 A1
(43) Pub. Date: Oct. 13, 2005

(54) Machine horse control system and control method thereof

(76) Inventors: Kuo-Lien Huang, Hsinchu (TW); Jr-Huang Shiau, Hsinchu (TW); Fang-Pang Lin, Hsinchu (TW)

Correspondence Address: RABIN & BERDO, P.C., Suite 500, 1101 14 Street, N.W., Washington, DC, 20005, US

(21) Appl. No.: 10/812,094

(22) Filed: Mar. 30, 2004

(51) Int. Cl. G05B 19/18

(52) U.S. Cl. 700/2; 700/56

(57) ABSTRACT

A machine horse control system and its controlling method are provided. An OS unit, a central controlling unit, and a controlled object are included in the system. The OS unit completes a power on procedure via a network interface and receives a control command via another network interface. The central controlling unit receives the control command. The controlled object executes the corresponding operations according to the control command. Using the disclosed control system and method, one can perform a diskless power on procedure via a network. Therefore, it is not necessary to install a huge operating system in the machine horse control system.

### BACKGROUND OF THE INVENTION

1. Field of Invention

The invention relates to a machine horse control system and, in particular, to a wireless machine horse control system.

2. Related Art

Wildlife photography is an important means for studying wildlife, providing researchers with records and observation from various perspectives. In order to avoid close encounter to frighten or interfere the life of wild animals, one usually take pictures from a far distance.

When human beings take pictures from a short distance or observe birds, it is impossible to have some extent of influence on their behaviors and habits. If we can adopt an appropriate method, such interference of picture taking can be reduced to minimum.

In view of the foregoing, a device called the machine horse is invented. In the prior art, one uses a PC104 controller loaded with an operating system (OS) to control the motion of the machine horse via a control system and a microprocessor chip. The machine horse can be installed with a video camera, a recorder or a photo camera to record the activities of a target without interfering it.

However, the PC104 controller stores all control-related software. This requires the user of a more expensive chip. Therefore, the cost of the whole system is higher.

### SUMMARY OF THE INVENTION

A primary objective of the invention is to provide a machine horse control system. It solves the problems in the prior art by utilizing the diskless power on technique.

To achieve the above objective, the disclosed machine horse control system contains an OS unit, which completes the power on procedure via a network interface and receives a control command via another network interface; a central control unit, which is connected to the OS unit via a connection module for receiving the control command; and a controlled object, which is connected to the central controlling unit for executing an operation corresponding to the control command.

In accord with the objective, the invention further provides a machine horse system control method. The method includes the steps of: (a) providing an OS for an OS unit; (b) connecting the OS unit to a server via a network in order to perform a system power on procedure; (c) updating drivers in the OS to complete a power on procedure; (d) the OS unit's connecting to a control server via a wireless network interface to receive a control command from the control server; and (e) controlling the motion of the controlled object after the OS unit receives the control command.

The disclosed method further includes the steps of: (f) collecting data surrounding the controlled object; (g) transmitting the obtained data to the control server via the wireless network interface; (h) adjusting the control command according to the returned data; and (i) transmitting an adjusted control command to the OS unit.

The disclosed OS unit can perform a wireless power on procedure via a network. Therefore, there is no need to store a huge OS in the machine horse control system, thereby reducing the system cost.

In comparison with the prior art, the invention uses IP and wireless network control to obtain data. The power on kernel and relevant settings in PC104 are updated in a diskless power on fashion.

### BRIEF DESCRIPTION OF THE DRAWINGS

The invention will become more fully understood from the detailed description given hereinbelow illustration only, and thus are not limitative of the present invention, and wherein:

FIG. 1 shows a system structure of the disclosed machine horse control system;

FIG. 2 is a main flowchart of the disclosed machine horse control method;

FIG. 3 is a main flowchart of the disclosed machine horse control method;

FIG. 4 is a flowchart of preparing the OS in the disclosed method;

FIG. 5 is a flowchart of establishing the root file system;

FIG. 6 is a flowchart of establishing the kernel; and

FIG. 7 is a flowchart of installing a power on loading program.

### DETAILED DESCRIPTION OF THE INVENTION

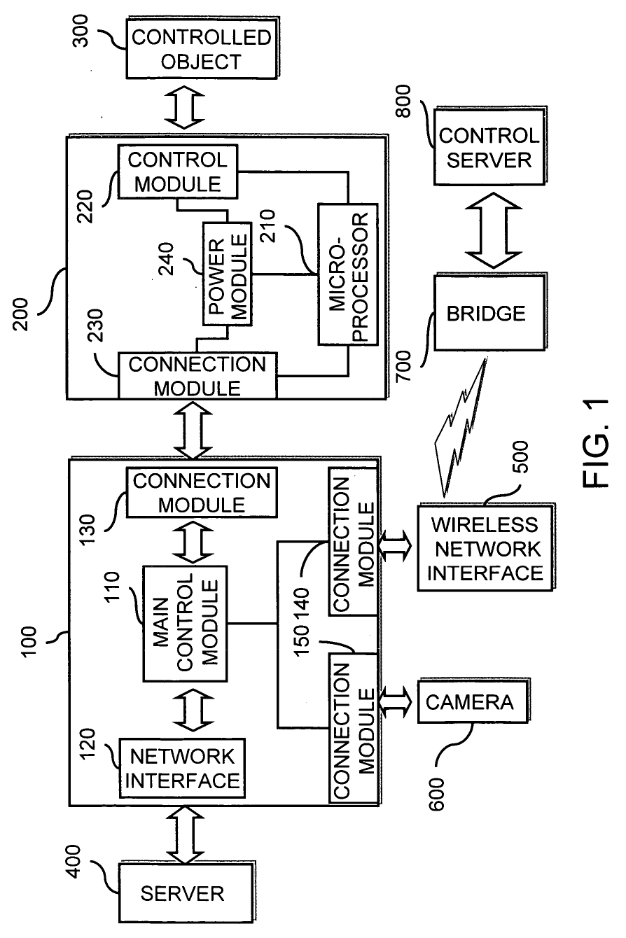

With reference to FIG. 1, the disclosed machine horse control system is comprised of an operating system (OS) unit 100, a central control unit 200, and a controlled object 300.

An embodiment of the controlled object 300 is a machine horse, a robot that looks like a horse. Other objects that receive the control commands from the central controlling unit 200 can also be the controlled objects.

The OS unit 100 has a main control module 110. The main control module 110 is connected with a network interface 120 and a connection module 130. The whole system can be connected to the Internet and a server 400 via a network interface 120. The OS unit 100 uses a PC 104 control board.

The control module 110 is a disk on module (DOM). The server 400 is a DRBL server, which is a diskless power on server. The kernel of the OS uses the Linux system. The machine horse control system is turned on via the connection with the diskless power on server.

The main control module 110 is selectively controlled with the connection module. For example, the connection module 140 is connected to the wireless network interface 500 and the camera 600. The connection module 140 and the connection module 150 can be connected to buses (e.g. IEEE1394) that link the system to other peripheral devices using a universal serial bus (USB) interface.

Through the connection with the wireless network interface 500, the system can be connected to a control server 800 in a wireless way via a bridge 700. Using the wireless networking method, the user can enter a command at the control server 800 and send it to the machine horse at a distance via the wireless network, thereby controlling the machine horse.

The central controlling unit 200 has a microprocessor 210, which connects to the control module 220 and the connection module 230. It also includes a power module 240 to provide the necessary power to the microprocessor 210, the control module 220, and the connection module 230.

The control module 220 is connected to the controlled object 300 for outputting a control command for the controlled object 300 to perform a corresponding operation.

The connection module 130 and the connection module 230 are connected using a connecting wire. The command signal output from the main control module 110 can therefore be sent to the microprocessor via the connection module 230. The connection module 130 and the connection module 230 can use an RS232 interface or other interfaces with the function of transmitting data.

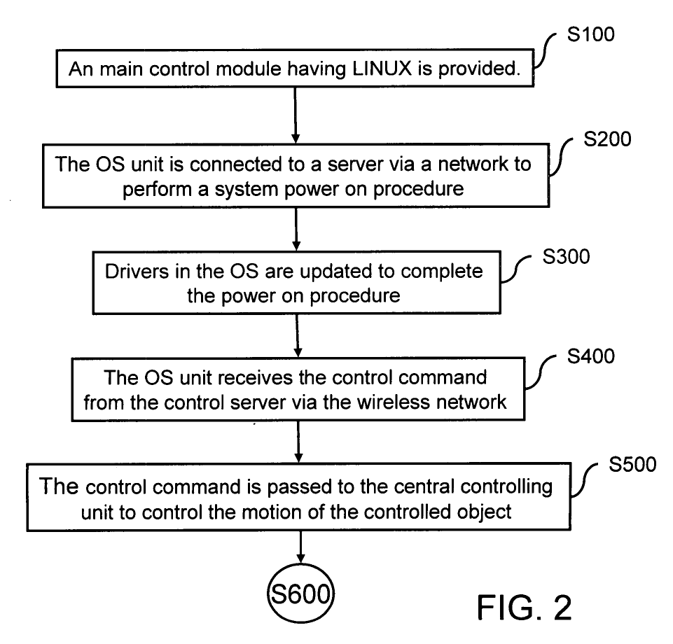

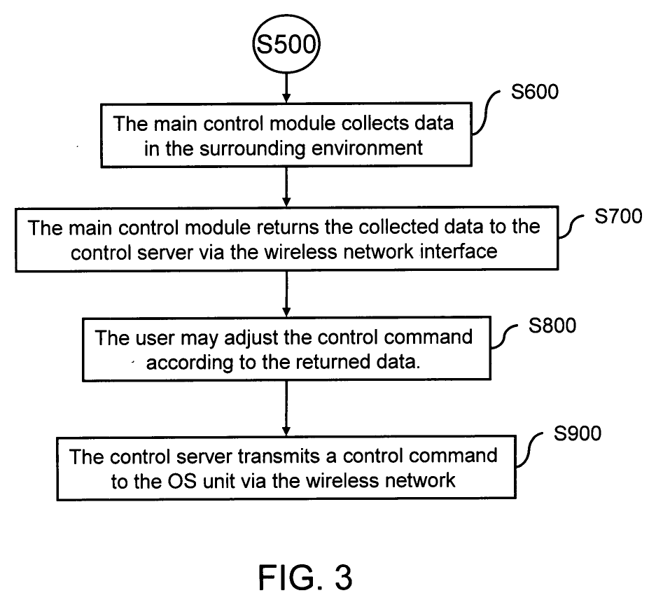

With reference to FIG. 2, the disclosed method first provides an OS for the main control module 110 in the OS unit 100 (step S100) so that the machine horse system can be turned on wirelessly.

The OS unit is then connected to a server via a network to perform a system power on procedure (step S200). Such a connection can be either wired or wireless. The server is the above-mentioned DRBL server. Drivers (e.g. those for network cards, cameras, etc) in the OS are updated to complete the power on procedure (step S300).

Once the power on procedure is completed, the method starts system operations. The OS in the main control module 110 is connected to the control server 800 via the wireless network interface 500 and the bridge 700. The disclosed machine horse system then controls a distant system through a wireless network.

In this case, the user enters a control command at the control server. The control command is transmitted over the bridge 700, and the OS unit receives the control command from the control server 800 via the wireless network (step S400).

After the OS unit 100 receives the control command, it is passed to the central controlling unit 200. The microprocessor 210 sends the control command to the control module 220 to control the motion of the controlled object 300 (step S500).

Once the controlled object, the machine horse, receives the control command, it starts to collect data (e.g. using a video camera to record the target's activities) in the surrounding environment (step S600). After obtaining the data, the main control module 110 returns them to the control server via the wireless network interface (step S700). The user can thus observe the target's activities. And the user may adjust the control command according to the returned data (step S800). Finally, the control server transmits a new control command to the OS unit via the wireless network (step S900).

We further explain the details on how to prepare the main control module in the following paragraphs.

The OS in the main control module 110 is a Linux system. One can use the utility Emdebian to make a Linux subsystem and install related drivers (e.g. drivers for chips in the wireless network cards, drivers supporting real-time image transfer, or remote login programs for command management) therein. In order to include the control program, one has to install the utility uclibc for controlling the program.

Once the subsystem is completed, the DOM is updated via the network and the server 400. The server 400 is a DRBL host.

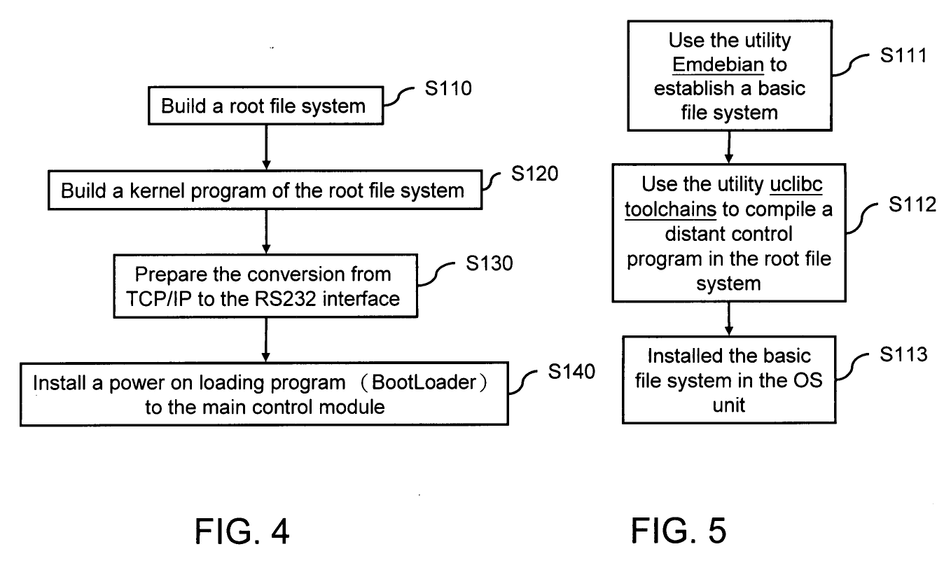

With reference to FIG. 4, we first build a root file system (step S110), then a kernel program of the root file system (step S120). Afterwards, we prepare the conversion from TCP/IP to the RS232 interface (step S130). Finally, we install a power on loading program to the main control module (step S140).

As shown in FIG. 5, we use the utility Emdebian to establish a basic file system (step S111). We then use the utility uclibc toolchains to compile a distant control program in the root file system (step S112). Afterwards, the basic file system with the remote login program is installed in the OS unit (step S113).

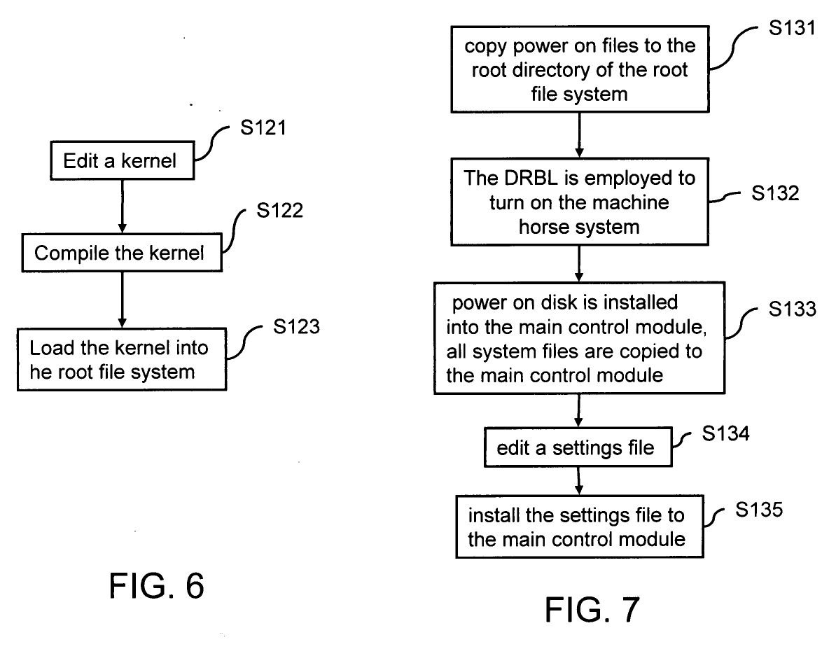

With reference to FIG. 6, we first edit a kernel (step S121), compile the kernel (step S122), and, after completing the compilation, load it into the root file system (step S123).

With reference to FIG. 7, we first copy power on files to the root directory of the root file system (step S131). The DRBL is then employed to turn on the machine horse system (step S132). Afterwards, a power on disk is installed into the main control module, all system files are copied to the main control module (step S133). We then edit a settings file lilo.conf for the utility lilo to use (step S134). In the end, we install the settings file to the main control module (step S135).

The machine horse control system disclosed herein uses a diskless power on means. The OS unit 100 supports a PXE network power on procedure. After it is turned on, a root directory along with all settings files are mounted from the server 400.

Certain variations would be apparent to those skilled in the art, which variations are considered within the spirit and scope of the claimed invention.

1. A machine horse control system, comprising:
an operating system (OS) unit, which completes a power on procedure via a network interface and receives a control command via another network interface;
a central controlling unit, which is connected to the OS unit via a connection module to receive the control command; and
a controlled object, which is connected to the central controlling unit for executing an operation corresponding to the control command.

2. The machine horse control system of claim 1, wherein the OS unit is a PC104 control card.

3. The machine horse control system of claim 1, wherein the OS unit contains a main control module that connects to the server via a network interface to complete the power on procedure and to receive the control command.

4. The machine horse control system of claim 3, wherein the main control module is a disk on module (DOM) chip.

5. The machine horse control system of claim 1, wherein the connection module is an RS232 interface.

6. The machine horse control system of claim 2, wherein the OS unit has a plurality of connection modules.

7. The machine horse control system of claim 6, wherein each of connection modules has a universal serial bus (USB) interface.

8. The machine horse control system of claim 1, wherein the central controlling unit contains:
a microprocessor, which receives the control command via a connection module; and
a control module, which controls the controlled object according to the control command.

9. The machine horse control system of claim 8, wherein the central controlling unit further includes a power module to providing necessary power for the microprocessor and the control module.

10. A machine horse control method comprising the steps of:
providing an OS for an OS unit;
connecting the OS unit to a server via a network in order to perform a system power on procedure;
updating drivers in the OS to complete a power on procedure;
the OS unit's connecting to a control server via a wireless network interface to receive a control command from the control server; and
the OS unit's controlling the motion of the controlled object after the OS unit receives the control command.

11. The method of claim 10 further comprising the steps of:
collecting data surrounding the controlled object;
transmitting the obtained data to the control server via the wireless network interface;
adjusting the control command according to the returned data; and
transmitting an adjusted control command to the OS unit.

12. The method of claim 10, wherein the step of providing an OS for an OS unit comprises the steps of:
establishing a root file system;
establishing a kernel for the OS; and
installing a power on loading program to the main control module.

13. The method of claim 10 wherein the step of establishing a root file system includes the steps of:
using a utility to build a basic file system;
compiling a remote login program in the root file system; and
installing the basic file system with the remote login program into the OS unit.

14. The method of claim 12, wherein the step of establishing a kernel for the OS includes the steps of:
editing the kernel;
compiling the kernel;
loading the compiled kernel into the root file system.

15. The method of claim 12, wherein the step of installing a power on loading program to the main control module includes the steps of:
turning on the machine horse system using a diskless distant power on procedure;
installing a power on disk and copying the root file system to the main control module;
editing a settings file; and
installing the settings file in the main control module.
